(19) United States
(12) Patent Application Publication
(10) Pub. No.: US 2012/0096497 A1
(43) Pub. Date: Apr. 19, 2012

(54) RECORDING TELEVISION CONTENT

(75) Inventors: True Xiong, San Diego, CA (US); Ling Jun Wong, Escondido, CA (US)

(73) Assignee: SONY CORPORATION, Tokyo (JP)

(21) Appl. No.: 12/904,999

(22) Filed: Oct. 14, 2010

(51) Int. Cl. H04N 5/445; H04N 7/173

(52) U.S. Cl. 725/50; 725/116; 725/109

(57) ABSTRACT

A method, in one embodiment, can include a server receiving data from a television via a communication medium. The data includes an identifier of a television channel that the television is tuned to. In addition, the server transmits a token to the television via the communication medium. Furthermore, the television transmits the token to a cloud storage via the communication medium. Moreover, the cloud storage stores a live broadcast television video from the television channel.

### BACKGROUND

Many people multi-task at home between watching television, cooking, texting, and doing laundry. For example, a person might want to check on boiling water in their kitchen or clothes drying in a dryer in their laundry room while watching their favorite live television episode. However, that person knows that if he or she goes away to try and accomplished any of these desired tasks or activities, he or she will possibly miss a portion of their favorite live television episode.

### SUMMARY

A method, in one embodiment, can include a server receiving data from a television via a communication medium. The data includes an identifier of a television channel that the television is tuned to. In addition, the server transmits a token to the television via the communication medium. Furthermore, the television transmits the token to a storage device via the communication medium. Moreover, the storage device stores a live broadcast television video from the television channel.

In another embodiment, a method can include a server receiving data from a television via a communication medium. The data includes an identifier of a television channel that the television is tuned to. Additionally, the server transmits a token to the television via the communication medium. Moreover, the television transmits the token to a cloud storage via the communication medium. Furthermore, the cloud storage stores a live broadcast television video from the television channel. In addition, the television receives a rewind signal.

In yet another embodiment, a method can include a server receiving data from a television via a communication medium. The data includes an identifier of the television and an identifier of a television channel that the television is tuned to. Furthermore, the server transmits a token to the television via the communication medium. The token includes the identifier of the television channel. In addition, the television transmits the token to a cloud storage via the communication medium. The cloud storage receives the token. Moreover, the cloud storage stores a live broadcast television video from the television channel.

While particular embodiments in accordance with the invention have been specifically described within this Summary, it is noted that the invention and the claimed subject matter are not limited in any way by these embodiments.

### BRIEF DESCRIPTION OF THE DRAWINGS

The accompanying drawings, which are incorporated in and form a part of this specification and in which like numerals depict like elements, are included to illustrate principles of the present embodiments and are not intended to limit the invention to the particular implementations illustrated therein.

FIG. 1A is a block diagram of a system for storing television content in accordance with various embodiments of the invention.

FIG. 1B is a block diagram of another system for storing television content in accordance with various embodiments of the invention.

FIGS. 2A and 2B are a flow diagram of a method for storing television content in accordance with various embodiments of the invention.

FIG. 3A is a timing sequence diagram for storing television content in accordance with an embodiment of the invention.

FIG. 3B is a block diagram of a television displaying a message in accordance with an embodiment of the invention.

FIG. 3C is a block diagram of a television displaying a user interface in accordance with one embodiment of the invention.

FIG. 4A is a timing sequence diagram for storing television content in accordance with another embodiment of the invention.

FIG. 4B is a block diagram of a television displaying another user interface in accordance with an embodiment of the invention.

FIG. 5 is a flow diagram of another method for storing television content in accordance with various embodiments of the invention.

FIG. 6 is a timing sequence diagram for storing television content in accordance with yet another embodiment of the invention.

FIG. 7 is a block diagram of another system for storing television content in accordance with various embodiments of the invention.

FIG. 8 is a block diagram of a computing system that can be used in accordance with various embodiments of the invention.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

Some portions of the detailed descriptions, which follow, are presented in terms of procedures, logic blocks, processing, and other symbolic representations of operations on data bits within a computing system or digital system memory. These descriptions and representations are the means used by those skilled in the art to most effectively convey the substance of their work to others skilled in the art. A procedure, logic block, process, etc., is herein, and generally, conceived to be a self-consistent sequence of operations or instructions leading to a desired result. The operations may involve physical manipulations of physical quantities. Usually, though not necessarily, these physical manipulations take the form of electrical or magnetic signals capable of being stored, transferred, combined, compared, and otherwise manipulated in a computing system or similar electronic computing device.

Unless specifically stated otherwise as apparent from the following discussions, it is understood that throughout discussions of embodiments in accordance with the invention, discussions utilizing terms such as “storing”, “determining”, “transmitting”, “downloading”, “receiving”, “generating”, “creating”, “utilizing”, “enabling”, “collecting”, “disallowing”, “restricting”, “deleting” or the like, can refer to the action and processes of a computing system, or similar electronic computing device, that manipulates and transforms data. The data can be represented as physical (electronic) quantities within the computing system's registers and memories and can be transformed into other data similarly represented as physical quantities within the computing system's memories or registers or other such information storage, transmission, or display devices.

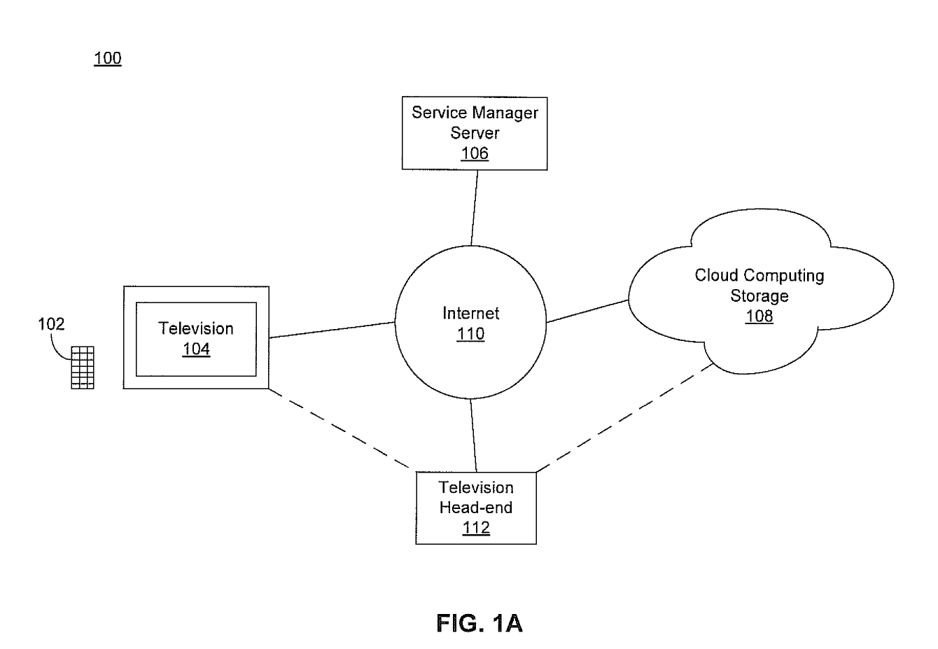

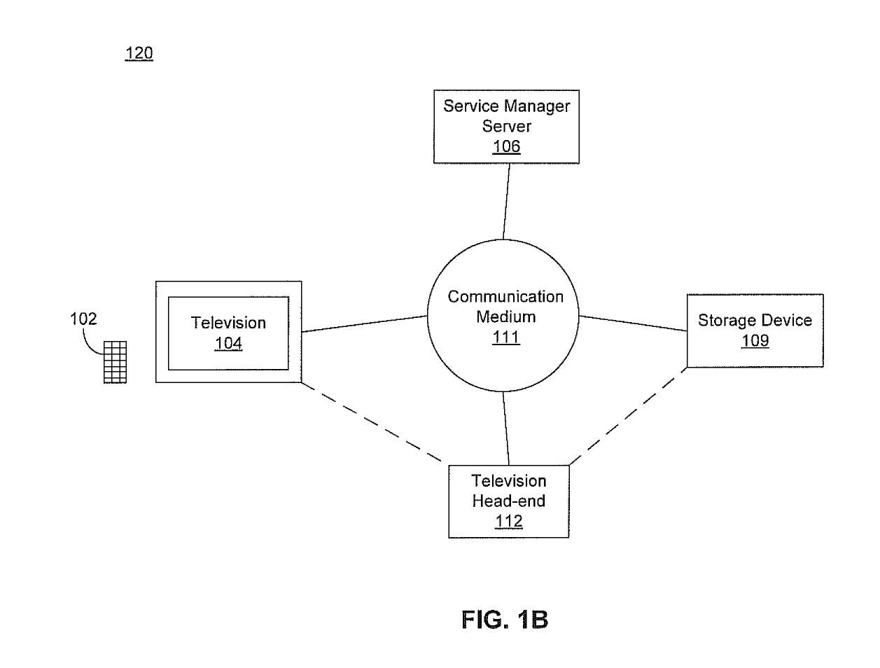

FIG. 1A is a block diagram of a system 100 for recording television broadcasts in accordance with various embodiments of the invention. For example, the system 100 can include, but is not limited to, a television 104 and its corresponding control device 102, a service manager server 106, a cloud computing storage (or cloud storage) 108, a television head-end 112, and the Internet 110. Specifically, the television 104, the service manager server 106, the cloud computing storage 108, and the television head-end 112 can each be coupled to the Internet 110, thereby enabling them to communicate.

In one embodiment, a user can be watching a live television show episode displayed by the television 104. As some point during the episode, the user may desire to go to another room, such as, the kitchen to check on something that is cooking in an oven. As such, before leaving to check the oven, the user can press an “Option” button on the television control device 102 in order to select an “Away” setting. Alternatively, in an embodiment, the user can press a “Pause” button on the television control device 102. After the “Away” setting is selected or the “Pause” button is pressed, the television 104 initiates a background process for storing the live television video into the cloud computing storage 108 (e.g., while the user is away).

Within FIG. 1A, in one embodiment, the background process can begin as the television 104 displays a message that states, for example: “AWAY and television video is storing.” Furthermore, the television 104 can validate itself with the service manager server 106 via the Internet 110, which begins a process resulting in live television video being stored by the cloud computing storage 108 that is associated with an account for the television 104. In addition, a dynamic process in the background creates a video icon link associated with the live television video and the link can be added to a list corresponding to the account for the television 104.

When the user returns to the television 104, in an embodiment, the user can press the “Option” button on the television control device 102 in order to select a “Back” (or “Return”) setting. Alternatively, in one embodiment, the user can press the “Pause” button again on the television control device 102. After the user has confirm to the television that he or she has returned, the television 104 can display a user interface that gives the user two options: watch the stored live television video now or watch it later? If the user selects to watch the stored live television video now (e.g., by utilizing the television control device 102), the stored live television video can be retrieved from the cloud computing storage 108 and then played back and displayed by the television 104. Note that during playback of the stored live television video, the television 104 can enable the user to fast forward, rewind, or skip ahead the stored video via the television control device 102.

Within FIG. 1A, if the user selects to watch the stored live television video later, he or she can continue watching the live broadcast of the live television show episode. As some later time, in one embodiment, the user can press the “Option” button on the television control device 102 in order to select a “Video List” option. After the selection of the “Video List” option, the television 104 can generate and display a listing of stored live television video clips or segments that are available for viewing on television 104. Using the television control device 102, the user can select and watch the previously recorded live television video segment that the user missed while away from the television 104.

Note that as the user uses this feature more and more, the live television video segments are stored to the cloud computing storage 108. In an embodiment, the cloud computing storage 108 can store or record the live television video utilizing, but is not limited to, a circular storage buffer that overwrites itself when the video data exceeds a predefined maximum storage size or space of the circular buffer (e.g., 10 gigabytes (GB) or any other amount of storage). As such, when the video data exceeds the limit of the circular buffer, the cloud computing storage 108 can cause the new live television video to overwrite older stored video.

However in one embodiment of FIG. 1A, before the video data exceeds the storage limit of the circular buffer, the cloud computing storage 108 can determine if there are any stored video segments at or near the beginning of the circular buffer that are to be saved for possible retrieval by the television 104. For example, the video segments that are to be saved may be those that have not been retrieved (e.g., to be viewed by a user) or have not been marked to be overwritten or deleted by the cloud computing storage 108. If there are any stored video segments to save, the cloud computing storage 108 can move them to other storage space (e.g., toward the end or back section of the circular buffer) so that there is plenty of free storage space at the beginning or front section of the circular buffer. In this manner, the cloud computing storage 108 can optimize the available storage space within each circular buffer. Note that in one embodiment, the cloud computing storage 108 can perform this optimization during a down time of a particular circular buffer, but is not limited to such.

In an embodiment, before the video data exceeds the storage limit of the circular buffer, the cloud computing storage 108 can notify the television 104 of the situation. As such, the television 104 can generate and display a user interface (e.g., GUI) that can provide the user options for saving or deleting stored video at or near the beginning of the circular buffer that has not been viewed or has not been marked to be overwritten by the cloud computing storage 108. In one embodiment, after a predefined amount of time has elapsed, the cloud computing storage 108 can delete video content frame by frame from the circular buffer. In an embodiment, the cloud computing storage 108 can archive the stored television video content.

Within FIG. 1A, note that the television 104 can be implemented in a wide variety of ways. For example, the television 104 can be implemented as, but is not limited to, an Internet Protocol television (IPTV) device, a Digital Living Network Alliance (DLNA) defined television, a television that includes a computing system, and the like. In addition, the television control device 102 can be implemented in a wide variety of ways. For example, the television control device 102 can be implemented as, but is not limited to, a wireless television remote control device, a wireless universal remote control device, a control device incorporated as part of the television 104, and the like. It is pointed out that the television head-end 112 can be implemented in a wide variety of ways. For example, the television head-end 112 can be implemented as, but is not limited to, an Internet television head-end or provider, a cable television head-end or provider, a satellite television head-end or provider, a broadcast television head-end or provider, and the like. Note that in one embodiment, the television head-end 112 can be coupled to the television 104 via the Internet 110. However, in various embodiments, the television head-end 112 can be coupled to the television 104 via, but is not limited to, cable television technology, satellite television technology, and broadcast television technology (which are represented by the dashed line between the television 104 and the television head-end 112). In addition, in various embodiments, the television head-end 112 can be coupled to the cloud computing storage 108 via, but is not limited to, cable television technology, satellite television technology, and broadcast television technology (which are represented by the dashed line between the television head-end 112 and the cloud computing storage 108).

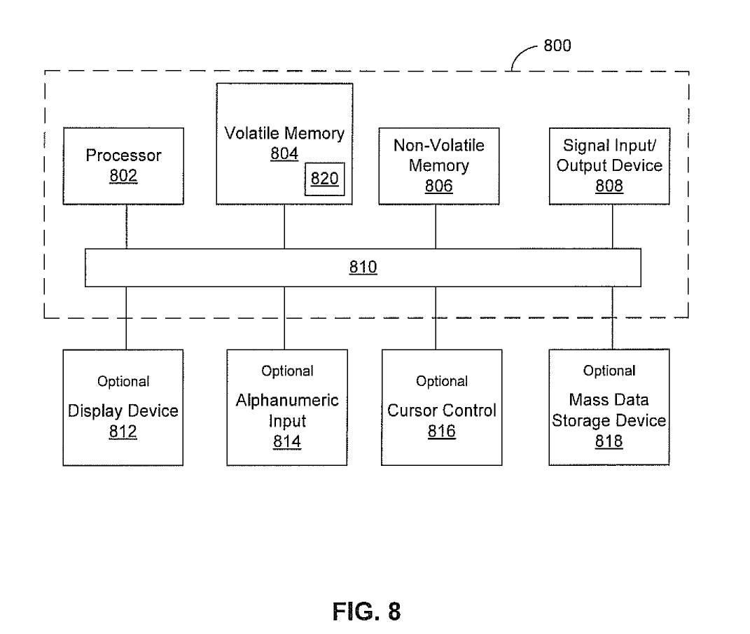

It is pointed out that the cloud computing storage 108 can be implemented in a wide variety of ways. For example, the cloud computing storage 108 can be implemented with, but not limited to, one or more servers, one or more virtual servers, or any combination thereof. The service manager server 106 can be implemented in a wide variety of ways. For example, the service manager server 106 can be implemented with, but not limited to, one or more servers, one or more service manager servers, or any combination thereof. It is noted that in one embodiment, the television 104 and the service manager server 106 can each be implemented in a manner similar to computing system 800 of FIG. 8, but is not limited to such.

Within FIG. 1A, it is noted that the Internet 110 can be implemented in a wide variety of ways. For example, the Internet 110 can include, but is not limited to, one or more local area networks (LANs), one or more wide area networks (WANs), one or more wired communication technologies, one or more wireless communication technologies, or any combination thereof. In addition, in various embodiments, it is noted that one or more communication medium can be implemented instead of or in combination with the Internet 110 within the system 100. For example, in various embodiments, the one or more communication medium that can be implemented instead of the Internet 110 within the system 100 can include, but are not limited to, one or more Digital Living Network Alliance (DLNA) defined networks, one or more local area networks (LANs), one or more wide area networks (WANs), one or more wired communication technologies, one or more wireless communication technologies, one or more communication protocols, or any combination thereof. It is pointed out that in various embodiments, any of these one or more communication medium can be implemented in combination with the Internet 110 within the system 100. In accordance with various embodiments, note that anywhere the Internet 110 or the Internet is mentioned herein, one or more communication medium can be substituted for or in combination with it as described herein, but are not limited to such.

It is noted that the system 100 may not include all of the elements illustrated by FIG. 1A. Additionally, the system 100 can be implemented to include one or more elements not illustrated by FIG. 1A. It is pointed out that the system 100 can be utilized or implemented in any manner similar to that described herein, but is not limited to such.

FIG. 1B is a block diagram of a system 120 for recording television broadcasts in accordance with various embodiments of the invention. Note that the system 120 of FIG. 1B can operate in a manner similar to the system 100 of FIG. 1A. However, within the system 120 of FIG. 1B, the storage device 109 can be utilized to store the live television video segment in accordance with an embodiment. In one embodiment, the television 104 can generate and display a user interface (e.g., GUI) that enables a user to select where to store or record live television video content. For example, the user interface may include a list of one or more storage devices (e.g., 109) that are able to store or record live television video content. Once a user has selected the storage device 109 using the television control device 102, for example, the television 104 can transmit that information to the service manager server 106. After this information is transmitted to the service manager server 106, live television video content can be stored or recorded by the storage device 109.

It is pointed out that the storage device 109 can be implemented in wide variety of ways. For example, the storage device 109 can be implemented as, but is not limited to, a mobile telephone, a smart phone, an MP3 player, a laptop computer, a desktop computer, a personal digital assistant (PDA), a hand-held computing device, a Digital Living Network Alliance (DLNA) device, and a computing device. In one embodiment, the system 120 can be implemented with multiple storage devices similar to the storage device 109, or multiple televisions similar to the television 104, or multiple television head-ends similar to television head-end 112, or any combination thereof.

Within FIG. 1B, in one embodiment, a user can utilize the television control device 102 to activate (or turn on) and tune the television 104 to a specific television channel. At some later time, the user may have a reason to temporarily step away from watching the tuned television show. As such, the user can utilize the television control device 102 to generate an “away” signal (or a pause live television signal) that is received by the television 104. After receiving the “away” signal (or the pause live television signal), the television 104 can generate and display a message indicating that the storing or recording of the current television show content is taking place.

Next, the television 104 can log into the service manager server 106 via the communication medium 111 to start the process of storing the video content of the currently tuned television show. After the log-in process, the service manager server 106 can transmit a user token (e.g., that can include information for storing the television show) to the television 104 via the communication medium 111. The television 104 receives the user token and transmits it to the storage device 109 via the communication medium 111. The storage device 109 receives the user token, extracts information from it, and starts storing (or capturing or recording) the live television show video of the tuned channel of the television 104. In one embodiment, the storage device 109 can receive the live television show video from the television head-end 112 or the television 104 via the communication medium 111. In an embodiment, the storage device 109 can receive the live television show video from the television head-end 112 via, but not limited to, cable television technology, satellite television technology, and broadcast television technology (represented by the dashed line between the television head-end 112 and the storage device 109).

Within FIG. 1B, while storing the live television show video of the tuned channel of the television 104, the storage device 109 can create a reference link (e.g., a Uniform Resource Identifier (URI)) corresponding to the specific television video being captured and can transmit the reference link to the service manager server 106 via the communication medium 111. At some later time when the user returns to watch the television 104, the user can cause the television control device 102 to generate or convey a “confirm back” or un-pause signal which is received by the television 104. After receiving the “confirm back” or un-pause or play signal, the television 104 can generate and display a user interface that includes viewing options corresponding to the stored video: watch the stored video now or later?

Using the user interface, the user can cause the television control device 102 to generate or convey a “watch now” selection to the television 104 indicating that the user wants to watch the recorded video now. After receiving the “watch now” selection, the television 104 can transmit a request for the stored video to the service manager server 106 via the communication medium 111. After receiving the request for the stored video, the service manager server 106 can transmit to the television 104 via the communication medium 111 the corresponding storage information for the stored video within the storage device 109. After receiving the storage information, the television 104 can utilize it to retrieve the stored video from the storage device 109 via the communication medium 111. After receiving the stored video, the television 104 can then playback and display the stored video and can also enable a user to rewind, fast forward, and skip ahead the stored video during its playback using the television control device 102. Note that the storage device 109 can continue to store the live television show until the user reaches the point where there is not any remaining stored video to fast forward through or skip ahead during its playback. In other words, the user has no more stored video to watch since he or she has caught up to the live television show being broadcast on the tuned television channel. At that point, the television 104 can transmit a stop signal to the storage device 109 which causes the storage device 109 to stop recording the live television show.

Within FIG. 1B, using the user interface, the user can cause the television control device 102 to generate or convey a “watch later” selection to the television 104 indicating that the user wants to watch the recorded video later. After receiving the “watch later” selection, the television 104 can display the live television show being broadcast on the tuned television channel. In addition, the television 104 can transmit a stop signal to the storage device 109 via the communication medium 111 directing it to stop capturing or storing video of the tuned television channel. Note that upon reception of the stop signal, the storage device 109 can stop storing video of the tuned channel of the television 104.

At some later time, the user can cause the television control device 102 to generate or convey a request to the television 104 to display a listing of any stored videos that are available for playback to a specific user or account. After receiving the request, the television 104 can transmit a request to the service manager server 106 via the communication medium 111 for a listing of any stored videos that are available for playback to the user or the account. After receiving the request for the stored video list, the service manager server 106 can transmit to the television 104 via the communication medium 111a listing of any videos stored by the storage device 109 that are available for playback to the user or the account. Note that in one embodiment, the listing can include the reference links corresponding to the stored videos that are available for playback to the user or the account. After receiving the listing of any stored videos, the television 104 can generate and display a user interface that may include a listing of stored videos that are available for playback (if any) for the particular user or the specific account.

Within FIG. 1B, at some later time the television 104 may receive a selection of a stored video for playback from the displayed user interface listing. After receiving the request for the selected stored video, the television 104 can transmit a request for the selected stored video to the service manager server 106 via the communication medium 111. After receiving the request for the selected stored video, the service manager server 106 can transmit to the television 104 via the communication medium 111 the corresponding storage information of the selected stored video within the storage device 109. After receiving the storage information, the television 104 can use it to retrieve the selected stored video from the storage device 109 via the communication medium 111. After receiving the selected stored video, the television 104 can then playback and display the selected stored video and can also enable the user to rewind, fast forward, and skip ahead the selected stored video during playback.

It is pointed out that communication medium 111 can be implemented in a wide variety of ways. For example, the communication medium 111 can be implemented as, but is not limited to, one or more communication medium, one or more Digital Living Network Alliance (DLNA) defined networks, one or more local area networks (LANs), one or more wide area networks (WANs), one or more wired communication technologies, one or more wireless communication technologies, one or more communication protocols, the Internet, or any combination thereof.

Within FIG. 1B, the system 120 can include, but is not limited to, the television 104 and its corresponding control device 102, the service manager server 106, the storage device 109, the television head-end 112, and communication medium 111. Specifically, the television 104, the service manager server 106, the storage device 109, and the television head-end 112 can each be coupled to the communication medium 111, thereby enabling them to communicate.

Note that the system 120 may not include all of the elements illustrated by FIG. 1B. Moreover, the system 120 can be implemented to include one or more elements not illustrated by FIG. 1B. It is pointed out that that system 120 of FIG. 1B can be implemented to operate in any manner similar to the system 100 of FIG. 1A as described herein, but not limited to such.

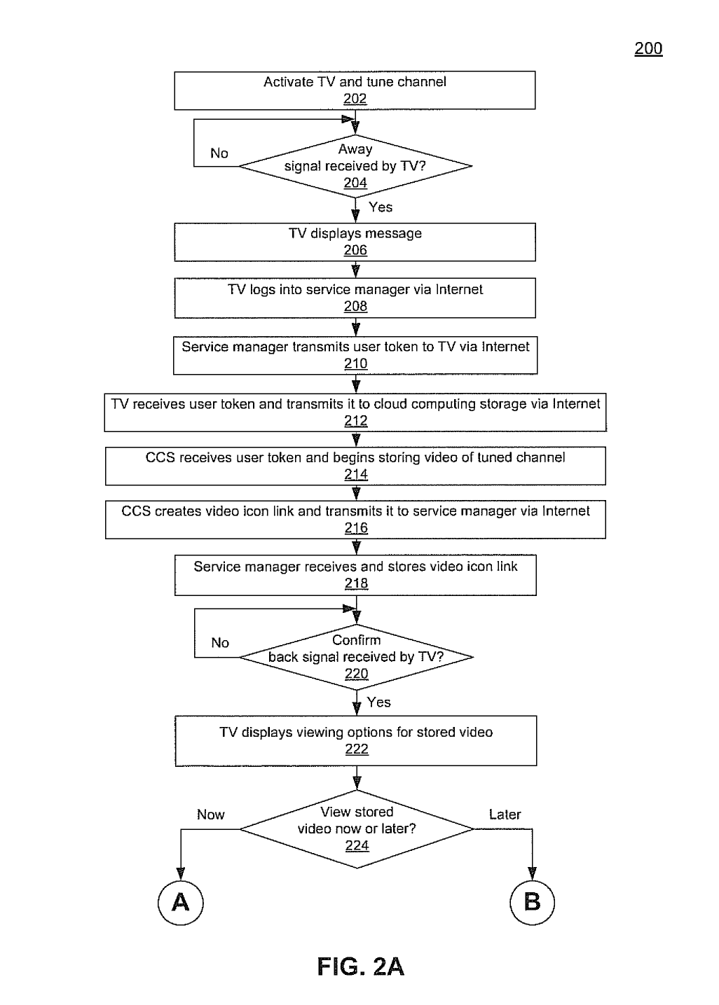

FIGS. 2A and 2B are a flow diagram of an example method (or process) 200 for storing television content in accordance with various embodiments of the invention. Although specific operations are disclosed in flow diagram 200, such operations are examples. Method 200 may not include all of the operations illustrated by FIGS. 2A and 2B. Also, method 200 may include various other operations and/or variations of the operations shown by FIGS. 2A and 2B. Likewise, the sequence of the operations of flow diagram 200 can be modified. It is appreciated that not all of the operations in flow diagram 200 may be performed. In various embodiments, one or more of the operations of method 200 can be implemented, controlled, and/or managed by software, by firmware, by hardware, or by any combination thereof, but is not limited to such. Method 200 can include processes of embodiments which can be implemented, controlled, and/or managed by a processor(s) and electrical components under the control of computer or computing device readable and executable instructions (or code). The computer or computing device readable and executable instructions (or code) may reside, for example, in data storage features such as computer or computing device usable volatile memory, computer or computing device usable non-volatile memory, and/or computer or computing device usable mass data storage. However, the computer or computing device readable and executable instructions (or code) may reside in any type of computer or computing device readable medium. It is noted that in one embodiment, method 200 can be implemented with the Bravia Internet Video Link (BIVL) infrastructure, but is not limited to such.

Specifically, at operation 202 of FIG. 2A, a television (e.g., 104) can be activated (or turned on) and tuned into a specific television channel (e.g., utilizing television control device 102). It is pointed out that operation 202 can be implemented in a wide variety of ways. For example in one embodiment, the television channel at operation 202 can be supplied by, but is not limited to, an Internet television provider (e.g., 112), a cable television provider, a satellite television provider, a broadcast television provider, and the like. Operation 202 can be implemented in any manner similar to that described herein, but is not limited to such.

At operation 204, a determination can be made as to whether an “away” signal (or a pause live television signal) has been received by the television. If not, method 200 can return to the beginning of operation 204. However, if the television has received an “away” signal (or a pause live television signal) at operation 204, method 200 can proceed to operation 206. It is noted that operation 204 can be implemented in a wide variety of ways. For example, the “away” signal (or the pause live television signal) can be generated by the television control device 102, but is not limited to such. Operation 204 can be implemented in any manner similar to that described herein, but is not limited to such.

At operation 206 of FIG. 2A, the television can generate and display a message indicating that the storing or recording of the current television show content is taking place. Note that operation 206 can be implemented in a wide variety of ways. For example, the message at operation 206 can state, but is not limited to: “AWAY—Live Television Video is Storing,” “AWAY—Live Television Video is Recording,” “Live Television is Currently Paused and is being Stored,” or “Live Television is Currently Paused and is being Recorded.” Operation 206 can be implemented in any manner similar to that described herein, but is not limited to such.

At operation 208, the television can log into a service manager server (e.g., 106) via the Internet (e.g., 110) to initiate the process of storing the video content of the currently tuned television show. It is pointed out that operation 208 can be implemented in a wide variety of ways. For example, the television can log into the service manager server at operation 208 using, but is not limited to, a user identification, a password, an account identification, a television identification, a television serial number, or any combination thereof. Operation 208 can be implemented in any manner similar to that described herein, but is not limited to such.

At operation 210 of FIG. 2A, after the log-in process, the service manager server can transmit a user token (e.g., that can include information for storing the television show) to the television via the Internet. It is noted that operation 210 can be implemented in a wide variety of ways. For example, the user token at operation 210 can include, but is not limited to, an Internet Protocol (IP) address of a cloud computing storage (e.g., 108), television channel identification, television show identification, a user identification, a password, an account identification, a television identification, a television serial number, or any combination thereof. Operation 210 can be implemented in any manner similar to that described herein, but is not limited to such.

At operation 212, the television receives the user token and transmits it to a cloud computing storage (e.g., 108) via the Internet. It is noted that operation 212 can be implemented in a wide variety of ways. For example in an embodiment, the television at operation 212 can utilize the IP address of the cloud computing storage from the user token to identify where to transmit the user token. Operation 212 can be implemented in any manner similar to that described herein, but is not limited to such.

At operation 214 of FIG. 2A, the cloud computing storage (CCS) receives the user token, extracts information from it, and begins storing or recording the live television show video of the tuned channel of the television. Note that operation 214 can be implemented in a wide variety of ways. For example in one embodiment, the cloud computing storage at operation 214 can store or record the live television video utilizing, but is not limited to, a circular buffer that overwrites itself when it exceeds a predefined maximum storage size. It is pointed out that in an embodiment, the cloud computing storage can assign a circular buffer to each user or each account (e.g., television account) or household, but is not limited to such. In addition, the cloud computing storage can receive the tuned television channel content from a television head-end (e.g., 112) or from the television, but is not limited to such. Operation 214 can be implemented in any manner similar to that described herein, but is not limited to such.

At operation 216, while storing the video, the cloud computing storage can create a video icon link corresponding to the specific television video being stored and can transmit the video icon link to the service manager server via the Internet. It is pointed out that operation 216 can be implemented in a wide variety of ways. For example in one embodiment, the video icon link at operation 216 can include, but is not limited to, a label including the name of the television show being stored, a time stamp corresponding to the beginning of the storing process, embedded information of where the stored television show is stored within the cloud computing storage, user identification, account identification, television identification, or any combination thereof. Operation 216 can be implemented in any manner similar to that described herein, but is not limited to such.

At operation 218 of FIG. 2A, the service manager server can receive and store the video icon link for later use within a user interface. It is noted that operation 218 can be implemented in a wide variety of ways. For example in an embodiment, the video icon link can be stored at operation 218 by the service manager server as part of a service list associated with a specific user identification, account identification, television identification, or any combination thereof. Operation 218 can be implemented in any manner similar to that described herein, but is not limited to such.

At operation 220, a determination can be made as to whether a “confirm back” or un-pause or play signal has been received by the television indicating that the user has returned to watch the television. If not, the determination at operation 220 can be repeated by method 200. However, if the television has received a “confirm back” or un-pause or play signal at operation 220, method 200 can proceed to operation 222. It is noted that operation 220 can be implemented in a wide variety of ways. For example in one embodiment, the “confirm back” or un-pause or play signal can be received externally or internally by the television from the television control device 102 at operation 220. In an embodiment, the television can receive at operation 220 the “confirm back” or un-pause or play signal via wired and/or wireless technology. Operation 220 can be implemented in any manner similar to that described herein, but is not limited to such.

At operation 222 of FIG. 2A, the television can generate and display a user interface that includes viewing options corresponding to the stored video. Note that operation 222 can be implemented in a wide variety of ways. For example in an embodiment, the user interface at operation 222 can include a question for a user, such as: “Would you like to watch the stored television video now or later?” or “View the stored television show video now or later?” or the like. In one embodiment, the user interface at operation 222 can be implemented with a graphical user interface (GUI), but is not limited to such. Operation 222 can be implemented in any manner similar to that described herein, but is not limited to such.

At operation 224, a determination can be made as to whether a selection has been made to watch the stored television video now or later. If the selection is made by a user to watch the stored video now, method 200 can proceed to operation 226 of FIG. 2B. However, if the selection is made by a user to watch the stored video later, method 200 can proceed to operation 246 of FIG. 2B. It is noted that operation 224 can be implemented in a wide variety of ways. For example in an embodiment, a user can utilize the television control device 102 to transmit or convey a “watch now” selection signal or a “watch later” selection signal, which can each be received externally or internally by the television at operation 224. Operation 224 can be implemented in any manner similar to that described herein, but is not limited to such.

At operation 226 of FIG. 2B, the cloud computing storage can continue storing video of the tuned channel of the television. It is noted that operation 226 can be implemented in a wide variety of ways. For example, operation 226 can be implemented in any manner similar to that described herein, but is not limited to such.

At operation 228, the television can transmit a request for the stored video to the service manager server via the Internet. It is noted that operation 228 can be implemented in a wide variety of ways. For example in one embodiment, the request at operation 228 can include, but is not limited to, television identification, user identification, account identification, the name of the stored television show video, the television channel which broadcast the stored television show video, the time and date when the storing process began (e.g. when the television received an “away” or pause signal at operation 204), or any combination thereof. Operation 228 can be implemented in any manner similar to that described herein, but is not limited to such.

At operation 230 of FIG. 2B, the service manager server can receive the request and transmits to the television via the Internet the corresponding storage information for the stored video within the cloud computing storage. Note that operation 230 can be implemented in a wide variety of ways. For example in an embodiment, the storage information at operation 230 for the stored video within the cloud computing storage can include, but is not limited to, one or more memory address locations within the cloud computing storage, and the IP address of the cloud computing storage for locating it on the Internet. Operation 230 can be implemented in any manner similar to that described herein, but is not limited to such.

At operation 232, the television can receive the storage information for the stored video and can utilize it to retrieve the stored video from the cloud computing storage via the Internet. It is pointed out that operation 232 can be implemented in a wide variety of ways. For example in one embodiment, the television at operation 232 can utilize the IP address of the cloud computing storage from the storage information to identify where to send a retrieval request via the Internet. In an embodiment, once the cloud computing storage is located, the television at operation 232 can utilize the one or more memory address locations to retrieve the stored video from the cloud computing storage. In an embodiment, once the stored video is retrieved from the cloud computing storage at operation 232, the cloud computing storage can mark or indicate that the stored video within the storage location or circular buffer can be deleted or overwritten with television video. Operation 232 can be implemented in any manner similar to that described herein, but is not limited to such.

At operation 234 of FIG. 2B, the television can then playback and display the stored video and can also enable a user to rewind, fast forward, and skip ahead the stored video during its playback. It is noted that operation 234 can be implemented in a wide variety of ways. For example in an embodiment, the rewind, fast forward, and skip ahead signals or instructions at operation 234 can each be generated by the television control device 102, but is not limited to such. Operation 234 can be implemented in any manner similar to that described herein, but is not limited to such.

At operation 236, a determination can be made as to whether a fast forward or skip ahead signal has been received by the television. If not, method 200 can return to the beginning of operation 234. However, if a fast forward or skip ahead signal has been received by the television at operation 236, method 200 can proceed to operation 238. It is noted that operation 236 can be implemented in a wide variety of ways. For example, operation 236 can be implemented in any manner similar to that described herein, but is not limited to such.

At operation 238 of FIG. 2B, a determination can be made as to whether there is any remaining stored video to fast forward through or skip ahead during playback. If so, method 200 can return to the beginning of operation 234. However, if there is not any remaining stored video to fast forward through or skip ahead during playback at operation 238, method 200 can proceed to operation 240. In other words, if there is not any remaining stored video to fast forward through or skip ahead during playback at operation 238, the user has no more stored video to watch since he or she has caught up to the live television show being broadcast on the tuned television channel. Note that operation 238 can be implemented in a wide variety of ways. For example, operation 238 can be implemented in any manner similar to that described herein, but is not limited to such.

At operation 240, the television can display the live television video being broadcast on the tuned television channel. It is pointed out that operation 240 can be implemented in a wide variety of ways. For example, the tuned television channel at operation 240 can be supplied by, but is not limited to, an Internet television provider (e.g., 112), a cable television provider, a satellite television provider, a broadcast television provider, and the like. Operation 240 can be implemented in any manner similar to that described herein, but is not limited to such.

At operation 242 of FIG. 2B, the television can transmit a stop signal to the cloud computing storage via the Internet directing it to stop storing video of the tuned television channel. It is noted that operation 242 can be implemented in a wide variety of ways. For example, operation 242 can be implemented in any manner similar to that described herein, but is not limited to such.

At operation 244, the cloud computing storage can receive the stop signal and can stop storing video of the tuned channel of the television. It is pointed out that operation 244 can be implemented in a wide variety of ways. For example, operation 244 can be implemented in any manner similar to that described herein, but is not limited to such. At the completion of operation 244, method 200 can be ended. Note that in one embodiment, after the stored video is viewed, the television can generate and display a user interface (e.g., GUI) that asks the user if he or she would like to delete the stored video?

At operation 246 of FIG. 2B, the television can display the live television show being broadcast on the tuned television channel. Note that operation 246 can be implemented in a wide variety of ways. For example, the tuned television channel at operation 246 can be supplied by, but is not limited to, a cable television provider, a satellite television provider, an Internet television provider (e.g., 112), a broadcast television provider, and the like. Operation 246 can be implemented in any manner similar to that described herein, but is not limited to such.

At operation 248, the television can transmit a stop signal to the cloud computing storage via the Internet directing it to stop storing video of the tuned television channel. It is pointed out that operation 248 can be implemented in a wide variety of ways. For example, operation 248 can be implemented in any manner similar to that described herein, but is not limited to such.

At operation 250 of FIG. 2B, the cloud computing storage can receive the stop signal and can stop storing video of the tuned channel of the television. It is noted that operation 250 can be implemented in a wide variety of ways. For example, in one embodiment, the cloud computing storage at operation 250 can stop storing video of the tuned channel of the television, can time stamp when the storing was stopped, and can transmit that information via the Internet to the service manager server to store as part of the video icon link. Operation 250 can be implemented in any manner similar to that described herein, but is not limited to such.

At operation 252, a determination can be made as to whether the television has received a request to display a listing of any stored videos that are available for playback to a user or an account. If not, method 200 can return to the beginning of operation 252. However, if the television has received a request to display a listing of the stored videos that are available for playback to a user or an account at operation 252, method 200 can proceed to operation 254. It is noted that operation 252 can be implemented in a wide variety of ways. For example in an embodiment, the request to display a listing of the stored videos can be generated by the television control device 102 at operation 252, but is not limited to such. Operation 252 can be implemented in any manner similar to that described herein, but is not limited to such.

At operation 254 of FIG. 2B, the television can generate and display a user interface that may include a listing of stored videos that are available for playback (if any) for a particular user or a specific account. Note that operation 254 can be implemented in a wide variety of ways. For example in an embodiment, the user interface that may include a listing of stored videos at operation 254 can be implemented with a graphical user interface (GUI), but is not limited to such. Furthermore in one embodiment, the listing of stored videos can include, but is not limited to, the name of each recorded video segment, the date each recorded video segment was recorded, the local time each recorded video segment was recorded (e.g., start time and end time), viewing time of each recorded video segment, or any combination thereof. In one embodiment, as part of operation 254, the television can request and received from the service manager server via the Internet any available video icon links associated with a particular user or account which can be incorporated into the user interface. Operation 254 can be implemented in any manner similar to that described herein, but is not limited to such.

At operation 256, a determination can be made as to whether the television has received a selection of a stored video for playback from the displayed user interface listing. If not, method 200 can return to the beginning of operation 256. However, if it is determined that the television has received a selection at operation 256, method 200 can proceed to operation 258. It is noted that operation 256 can be implemented in a wide variety of ways. For example in an embodiment, the selection at operation 256 can be generated by the television control device 102, wherein the selection can be received externally or internally by the television at operation 256. Operation 256 can be implemented in any manner similar to that described herein, but is not limited to such.

At operation 258 of FIG. 2B, the television can transmit a request for the selected stored video to the service manager server via the Internet. It is noted that operation 258 can be implemented in a wide variety of ways. For example in an embodiment, the request at operation 258 can include, but is not limited to, the name of the stored television show video, the television channel which broadcast the stored television show video, the time and date when the storing process began (e.g. when the television received an “away” or pause signal at operation 204), user identification, account identification, television identification, or any combination thereof. Operation 258 can be implemented in any manner similar to that described herein, but is not limited to such.

At operation 260, the service manager server can receive the request and transmits to the television via the Internet the corresponding storage information of the selected stored video within the cloud computing storage. It is noted that operation 260 can be implemented in a wide variety of ways. For example, the storage information at operation 260 of the selected stored video within the cloud computing storage can include, but is not limited to, one or more memory address locations within the cloud computing storage, and the IP address of the cloud computing storage to locate it on the Internet. Operation 260 can be implemented in any manner similar to that described herein, but is not limited to such.

At operation 262 of FIG. 2B, the television can receive the storage information of the stored video and can utilize it to retrieve the selected stored video from the cloud computing storage via the Internet. Note that operation 262 can be implemented in a wide variety of ways. For example in an embodiment, the television at operation 262 can utilize the IP address of the cloud computing storage from the storage information to identify where to send a retrieval request. In an embodiment, once the cloud computing storage is located, the television at operation 262 can utilize the one or more memory address locations to retrieve the selected stored video from the cloud computing storage. Operation 262 can be implemented in any manner similar to that described herein, but is not limited to such.

At operation 264, after receiving the selected stored video, the television can then playback and display it and can also enable a user to rewind, fast forward, and skip ahead the stored video during its playback. It is pointed out that operation 264 can be implemented in a wide variety of ways. For example in an embodiment, the rewind, fast forward, and skip ahead signals or instructions at operation 264 can each be generated by the television control device 102, but is not limited to such. At the completion of operation 264, method 200 can be ended.

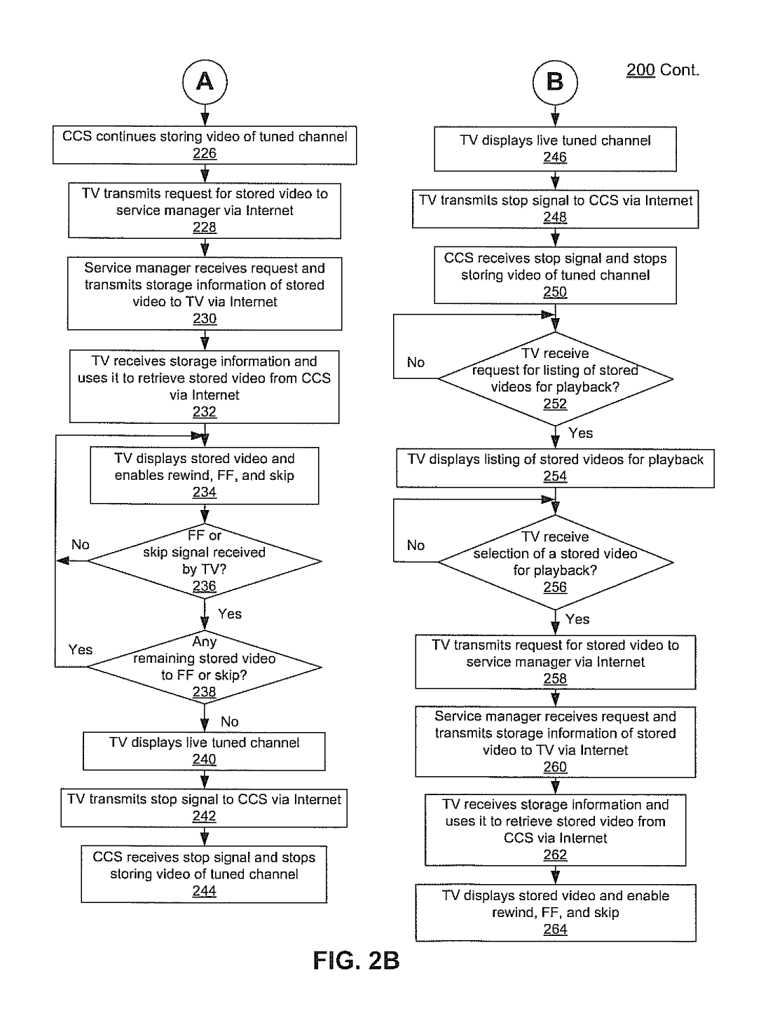

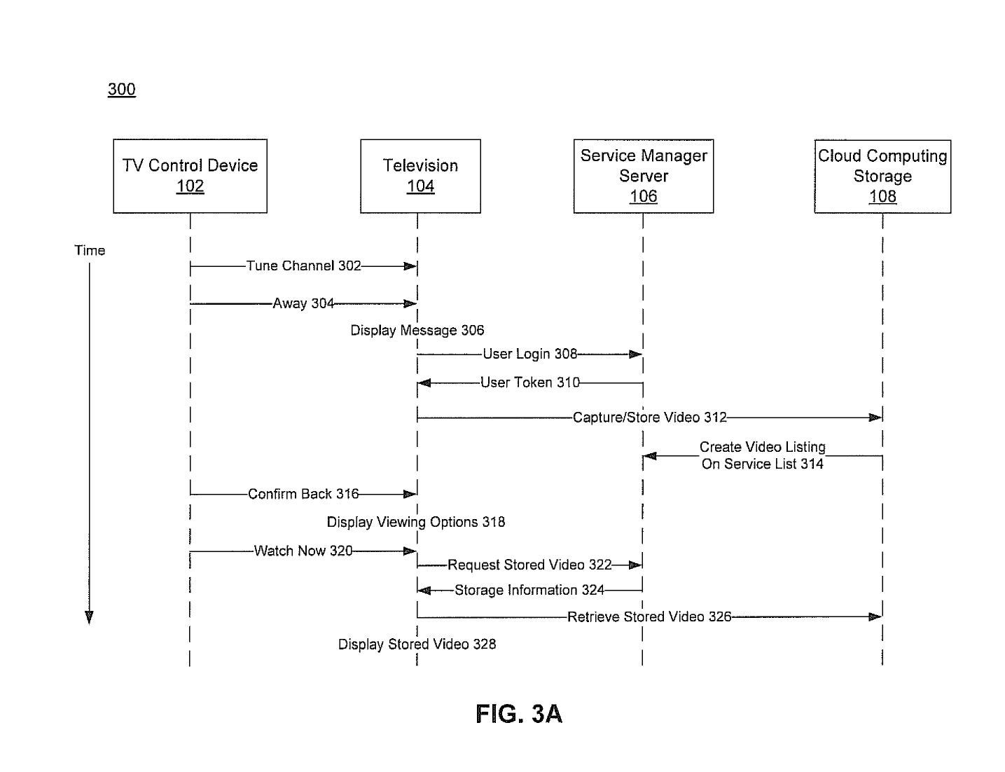

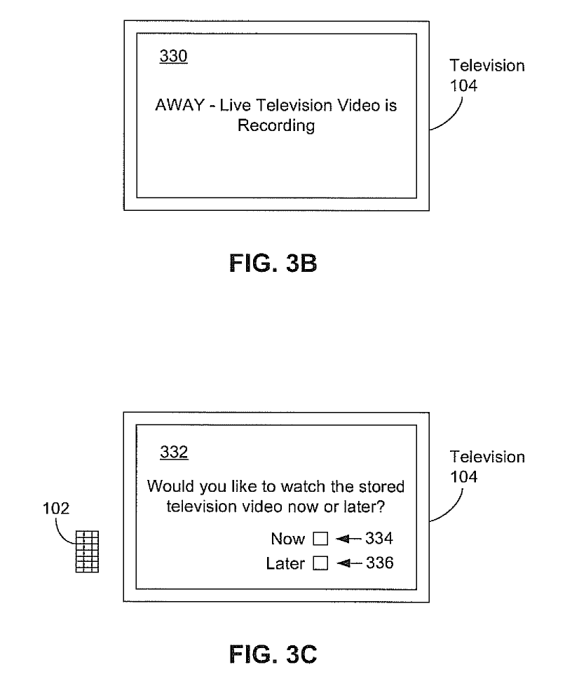

FIG. 3A is a timing sequence diagram 300 for storing television content in accordance with an embodiment of the invention. It is noted that within the timing sequence diagram 300, time progresses vertically down diagram 300 as represented by the vertical downward pointing “Time” arrow.

Within the timing sequence diagram 300, a user can utilize the television control device 102 to activate (or turn on) and tune the television 104 to a specific television channel, as represented by arrow 302. At some later time, the user may have a reason to temporarily step away from watching the tuned television show. As such, the user can utilize the television control device 102 to generate or convey an “away” signal (or a pause live television signal) that is received by the television 104, as represented by arrow 304. After receiving the “away” signal (or the pause live television signal), the television 104 can generate and display a message indicating that the storing or recording of the current television show content is taking place, as represented by “Display Message” 306. Note that the television 104 can generate and display a message in a wide variety of ways. For example, FIG. 3B is a block diagram of the television 104 displaying a message 330 in accordance with an embodiment of the invention. Specifically within the present embodiment, the message 330 states: “AWAY—Live Television Video is Recording”. However, it is pointed out that the message 330 can be implemented in any manner similar to that described herein, but is not limited to such.

Within FIG. 3A, the television 104 can log into the service manager server 106 via the Internet 110 to start the process of storing the video content of the currently tuned television show, as represented by arrow 308. After the log-in process, the service manager server 106 can transmit a user token (e.g., that can include information for storing the television show) to the television 104 via the Internet 110, as represented by arrow 310. The television 104 receives the user token and transmits it to the cloud computing storage 108 via the Internet 110, as represented by arrow 312. The cloud computing storage 108 receives the user token, extracts information from it, and starts storing (or capturing or recording) the live television show video of the tuned channel of the television 104, also represented by arrow 312.

While storing the live television show video of the tuned channel of the television 104, the cloud computing storage 108 can create a video icon link corresponding to the specific television video being captured and can transmit the video icon link to the service manager server 106 via the Internet 110, represented by arrow 314. At some later time when the user returns to watch the television 104, the user can cause the television control device 102 to generate or convey a “confirm back” or un-pause signal which is received by the television 104, represented by arrow 316. After receiving the “confirm back” or un-pause or play signal, the television 104 can generate and display a user interface that includes viewing options corresponding to the stored video, as represented by “Display Viewing Options” 318. Note that the television 104 can generate and display a viewing options user interface in a wide variety of ways. For example, FIG. 3C is a block diagram of the television 104 displaying a user interface 332 in accordance with one embodiment of the invention. Within the present embodiment, the user interface 332 includes the question: “Would you like to watch the stored television video now or later?” In addition, the user interface 332 can include a “Now” selection box 334 and a “Later” selection box 336. As such, a user can utilized the television control device 102 to select or choose the desired selection box shown within the user interface 332. It is noted that the user interface 332 can be implemented in any manner similar to that described herein, but is not limited to such.

Within FIG. 3A, the user can cause the television control device 102 to generate or convey a “watch now” selection to the television 104 indicating that the user wants to watch the recorded video now, as represented by arrow 320. After receiving the “watch now” selection, the television 104 can transmit a request for the stored video to the service manager server 106 via the Internet 110, as represented by arrow 322. After receiving the request for the stored video, the service manager server 106 can transmit to the television 104 via the Internet 110 the corresponding storage information for the stored video within the cloud computing storage 108, as represented by arrow 324.

After receiving the storage information, the television 104 can utilize it to retrieve the stored video from the cloud computing storage 108 via the Internet 110, as represented by arrow 326. After receiving the stored video, the television 104 can then playback and display the stored video and can also enable a user to rewind, fast forward, and skip ahead the stored video during its playback, as represented by “Display Stored Video” 328. Though not shown, it is noted that the cloud computing storage 108 can continue to store the live television show until the user reaches the point where there is not any remaining stored video to fast forward through or skip ahead during its playback. In other words, the user has no more stored video to watch since he or she has caught up to the live television show being broadcast on the tuned television channel.

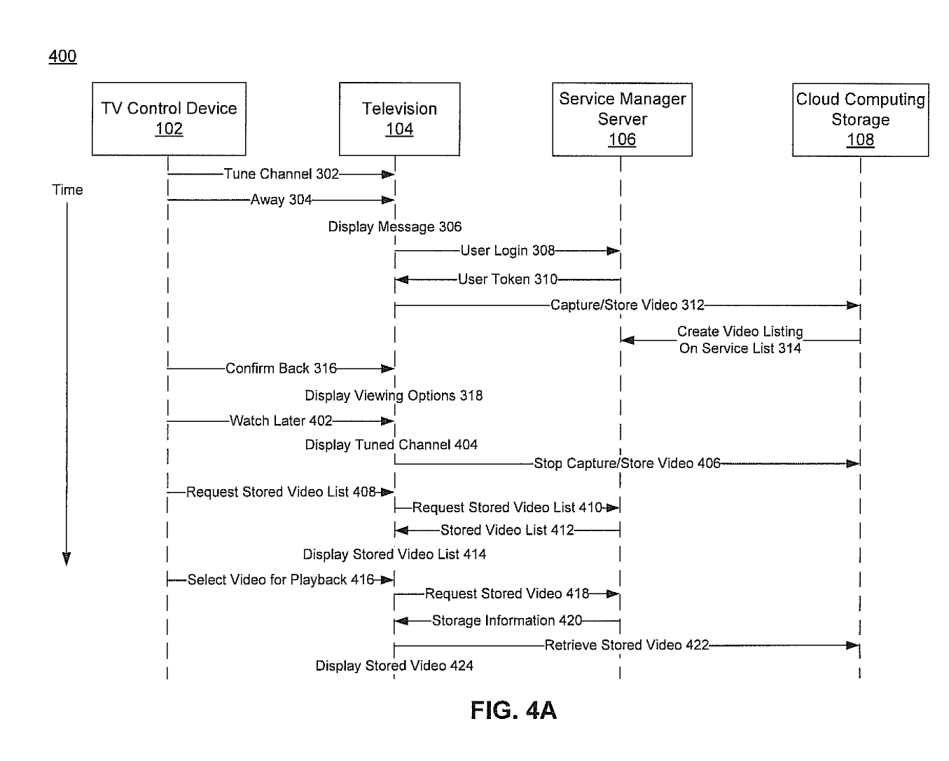

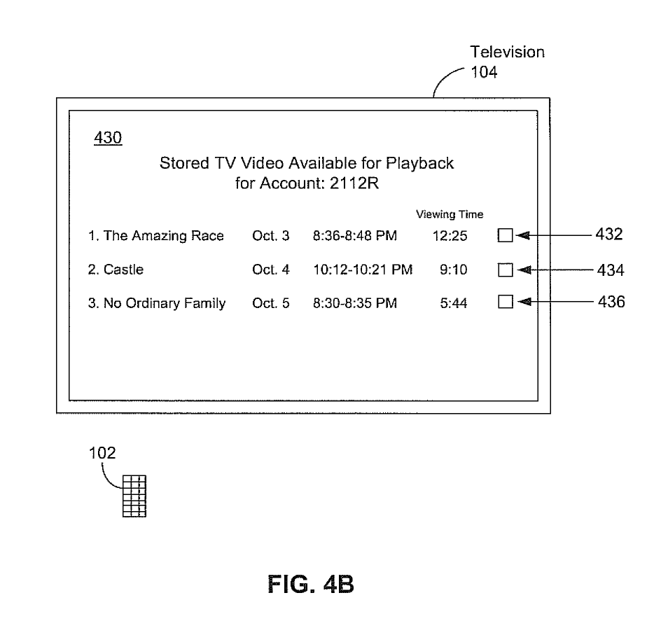

FIG. 4A is a timing sequence diagram 400 for storing television content in accordance with one embodiment of the invention. It is pointed out that within the timing sequence diagram 400, time progresses vertically down diagram 400 as represented by the vertical downward pointing “Time” arrow. In addition, it is noted that the operations associated with arrows 302, 304, 306, 308, 310, 312, 314, 316, and 318 of FIG. 4A are similar to the operations associated with arrows 302, 304, 306, 308, 310, 312, 314, 316, and 318 of FIG. 3A.

Within FIG. 4A, the user can cause the television control device 102 to generate or convey a “watch later” selection to the television 104 indicating that the user wants to watch the recorded video later, as represented by arrow 402. After receiving the “watch later” selection, the television 104 can display the live television show being broadcast on the tuned television channel, as represented by “Display Tuned Channel” 404. In addition, the television 104 can transmit a stop signal to the cloud computing storage 108 via the Internet 110 directing it to stop capturing or storing video of the tuned television channel, as represented by arrow 406. Note that upon reception of the stop signal, the cloud computing storage 108 can stop storing video of the tuned channel of the television 104.

At some later time, the user can cause the television control device 102 to generate or convey a request to the television 104 to display a listing of any stored videos that are available for playback to a specific user or account, as represented by arrow 408. After receiving the request, the television 104 can transmit a request to the service manager server 106 via the Internet 110 for a listing of any stored videos that are available for playback to the user or the account, as represented by arrow 410. After receiving the request for the stored video list, the service manager server 106 can transmit to the television 104 via the Internet 110 a listing of any videos stored by the cloud computing storage 108 that are available for playback to the user or the account, as represented by arrow 412. Note that in one embodiment, the listing can include the video icon links corresponding to the stored videos that are available for playback to the user or the account. After receiving the listing of any stored videos, the television 104 can generate and display a user interface that may include a listing of stored videos that are available for playback (if any) for the particular user or the specific account, as represented by “Display Stored Video List” 414. Note that the television 104 can generate and display a listing user interface in a wide variety of ways. For example, FIG. 4B is a block diagram of the television 104 displaying a user interface 430 in accordance with an embodiment of the invention. Within the present embodiment, the user interface 430 includes the account identification, the television show name of each recorded video segment, the date each recorded video segment was recorded, the start time and end time each recorded video segment was recorded, and the viewing time of each recorded video segment. Furthermore, the user interface 430 can include a selection box (e.g., 432, 434, or 436) corresponding to each recorded television video clip. As such, a user can utilized the television control device 102 to select or choose the desired stored video to watch via selection boxes 432, 434, and 436 shown within the user interface 430. It is pointed out that the user interface 430 can be implemented in any manner similar to that described herein, but is not limited to such.

Within FIG. 4A, at some later time the television 104 may receive a selection of a stored video for playback from the displayed user interface listing, as represented by arrow 416. After receiving the request for the selected stored video, the television 104 can transmit a request for the selected stored video to the service manager server 106 via the Internet 110, as represented by arrow 418. After receiving the request for the selected stored video, the service manager server 106 can transmit to the television 104 via the Internet 110 the corresponding storage information of the selected stored video within the cloud computing storage 108, as represented by arrow 420. After receiving the storage information, the television 104 can use it to retrieve the selected stored video from the cloud computing storage 108 via the Internet 110, as represented by arrow 422. After receiving the selected stored video, the television 104 can then playback and display the selected stored video and can also enable the user to rewind, fast forward, and skip ahead the selected stored video during playback, as represented by “Display Stored Video” 424.

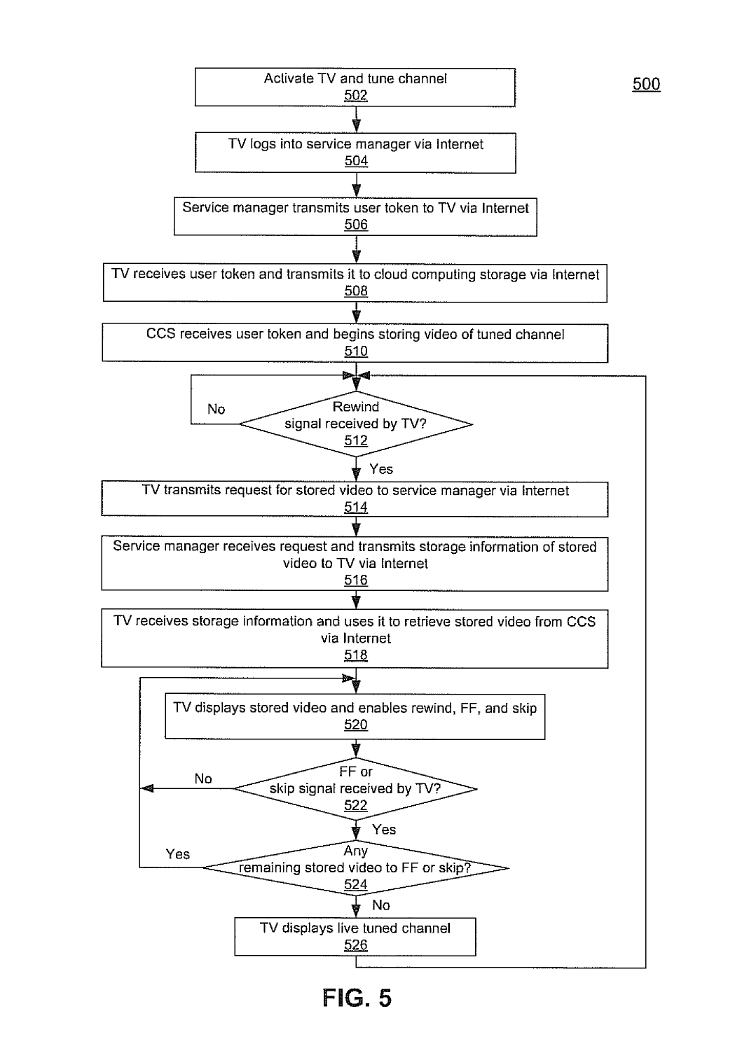

FIG. 5 is a flow diagram of an example method (or process) 500 for storing television content in accordance with various embodiments of the invention. Although specific operations are disclosed in flow diagram 500, such operations are examples. Method 500 may not include all of the operations illustrated by FIG. 5. Also, method 500 may include various other operations and/or variations of the operations shown by FIG. 5. Likewise, the sequence of the operations of flow diagram 500 can be modified. It is appreciated that not all of the operations in flow diagram 500 may be performed. In various embodiments, one or more of the operations of method 500 can be implemented, controlled, and/or managed by software, by firmware, by hardware, or by any combination thereof, but is not limited to such. Method 500 can include processes of embodiments which can be implemented, controlled, and/or managed by a processor(s) and electrical components under the control of computer or computing device readable and executable instructions (or code). The computer or computing device readable and executable instructions (or code) may reside, for example, in data storage features such as computer or computing device usable volatile memory, computer or computing device usable non-volatile memory, and/or computer or computing device usable mass data storage. However, the computer or computing device readable and executable instructions (or code) may reside in any type of computer or computing device readable medium. It is pointed out that in one embodiment, method 500 can be implemented with the Bravia Internet Video Link (BIVL) infrastructure, but is not limited to such.

Specifically, at operation 502 of FIG. 5, a television (e.g., 104) can be activated or turned on and tuned into a specific television channel (e.g., utilizing television control device 102). It is noted that operation 502 can be implemented in a wide variety of ways. For example in an embodiment, the television channel at operation 502 can be supplied by, but is not limited to, an Internet television provider (e.g., 112), a cable television provider, a satellite television provider, a broadcast television provider, and the like. Operation 502 can be implemented in any manner similar to that described herein, but is not limited to such.

At operation 504, the television can log into a service manager server (e.g., 106) via the Internet (e.g., 110) to begin the process of storing or recording the video content of the currently tuned television show. It is pointed out that operation 504 can be implemented in a wide variety of ways. For example, the television can log into the service manager server at operation 504 using, but is not limited to, a user identification, a password, an account identification, a television identification, a television serial number, or any combination thereof. Operation 504 can be implemented in any manner similar to that described herein, but is not limited to such.

At operation 506 of FIG. 5, after the log-in process, the service manager server can transmit a user token (e.g., that can include information for storing the television show) to the television via the Internet. Note that operation 506 can be implemented in a wide variety of ways. For example, the user token at operation 506 can include, but is not limited to, an Internet Protocol (IP) address of a cloud computing storage (e.g., 108), television channel identification, television show identification, a user identification, a password, an account identification, a television identification, a television serial number, or any combination thereof. Operation 506 can be implemented in any manner similar to that described herein, but is not limited to such.

At operation 508, the television receives the user token and transmits it to a cloud computing storage (e.g., 108) via the Internet. It is noted that operation 508 can be implemented in a wide variety of ways. For example in one embodiment, the television at operation 508 can utilize the IP address of the cloud computing storage from the user token to identify where to transmit the user token. Operation 508 can be implemented in any manner similar to that described herein, but is not limited to such.

At operation 510 of FIG. 5, the cloud computing storage (CCS) receives the user token, extracts information and/or data from it, and begins storing or recording the live television video of the tuned channel of the television. It is pointed out that operation 510 can be implemented in a wide variety of ways. For example in an embodiment, the cloud computing storage at operation 510 can store or record the live television video utilizing, but is not limited to, a circular buffer that overwrites itself when it exceeds a predefined maximum storage size. In one embodiment, the cloud computing storage can assign a circular buffer to each user or each account (e.g., television account) or household, but is not limited to such. Furthermore, the cloud computing storage can receive the tuned television channel content from either a television head-end (e.g., 112) or from the television, but is not limited to such. Operation 510 can be implemented in any manner similar to that described herein, but is not limited to such.

Note that in one embodiment, the cloud computing storage can continue storing or recording any live television video of whatever channel the television is tuned into during the remainder of method 500. Specifically, during operations 512, 514, 516, 518, 520, 522, 524, and 526, the cloud computing storage can continue storing or recording the live television video of any tuned in channel of the television (unless the television is turned off or deactivated).

At operation 512, a determination can be made as to whether a rewind signal has been received by the television. If not, method 500 can return to the beginning of operation 512. However, if a rewind signal has been received by the television at operation 512, method 500 can proceed to operation 514. It is pointed out that operation 512 can be implemented in a wide variety of ways. For example in an embodiment, the rewind signal or instruction at operation 512 can be generated by the television control device 102, but is not limited to such. In one embodiment, the rewind signal can be received externally or internally by the television at operation 512. Moreover, in an embodiment, the television can receive the rewind signal via wired and/or wireless technology. Operation 512 can be implemented in any manner similar to that described herein, but is not limited to such.

At operation 514 of FIG. 5, the television can transmit a request for the stored video to the service manager server via the Internet. It is noted that operation 514 can be implemented in a wide variety of ways. For example in one embodiment, the request at operation 514 can include, but is not limited to, the television identification, user identification, account identification, the name of the stored television show video, the television channel broadcasting the stored television show video, the time and date when the storing process began (e.g. when the television was activated and tuned into a specific television channel at operation 502), or any combination thereof. Operation 514 can be implemented in any manner similar to that described herein, but is not limited to such.

At operation 516, the service manager server can receive the request and transmits to the television via the Internet the corresponding storage information for the stored video within the cloud computing storage. It is pointed out that operation 516 can be implemented in a wide variety of ways. For example in an embodiment, the storage information at operation 516 for the stored video within the cloud computing storage can include, but is not limited to, one or more memory address locations within the cloud computing storage, and the IP address of the cloud computing storage for locating it on the Internet. Operation 516 can be implemented in any manner similar to that described herein, but is not limited to such.

At operation 518 of FIG. 5, the television can receive the storage information for the stored video and can utilize it to retrieve the stored video from the cloud computing storage via the Internet. It is noted that operation 518 can be implemented in a wide variety of ways. For example in one embodiment, the television at operation 518 can use the IP address of the cloud computing storage from the storage information to identify where to send a retrieval request via the Internet. In an embodiment, once the cloud computing storage is located, the television at operation 518 can utilize the one or more memory address locations to retrieve the stored video from the cloud computing storage. Operation 518 can be implemented in any manner similar to that described herein, but is not limited to such.

At operation 520, the television can then playback and display the stored video and can also facilitate the user with the functionality to rewind, fast forward, and skip ahead the stored video during its playback. Note that operation 520 can be implemented in a wide variety of ways. For example in one embodiment, the rewind, fast forward, and skip ahead signals or instructions at operation 520 can each be created or generated by the television control device 102, but is not limited to such. Operation 520 can be implemented in any manner similar to that described herein, but is not limited to such.

At operation 522 of FIG. 5, a determination can be made as to whether a fast forward or skip ahead signal has been received by the television. If not, method 500 can return to the beginning of operation 520. However, if a fast forward or skip ahead signal has been received by the television at operation 522, method 500 can proceed to operation 524. It is pointed out that operation 522 can be implemented in a wide variety of ways. For example, operation 522 can be implemented in any manner similar to that described herein, but is not limited to such.

At operation 524, a determination can be made as to whether there is any remaining stored video to fast forward through or skip ahead during playback. If so, method 500 can return to the beginning of operation 520. However, if there is not any remaining stored video to fast forward through or skip ahead during playback at operation 524, method 500 can proceed to operation 526. It is noted that if there is not any remaining stored video to fast forward through or skip ahead during playback at operation 524, the user has no more stored video to watch since he or she has caught up to the live television show being broadcast on the tuned television channel. Note that operation 524 can be implemented in a wide variety of ways. For example, operation 524 can be implemented in any manner similar to that described herein, but is not limited to such.

At operation 526 of FIG. 5, the television can display the live television video being broadcast on the tuned television channel. It is pointed out that operation 526 can be implemented in a wide variety of ways. For example, the tuned television channel at operation 526 can be supplied by, but is not limited to, an Internet television provider (e.g., 112), a cable television provider, a satellite television provider, a broadcast television provider, and the like. Operation 526 can be implemented in any manner similar to that described herein, but is not limited to such. Note that method 500 can proceed to the beginning of operation 512 while the television displays the live television video being broadcast on the tuned television channel at operation 526 and the cloud computing storage continues storing any live television video of any tuned in channel of the television.

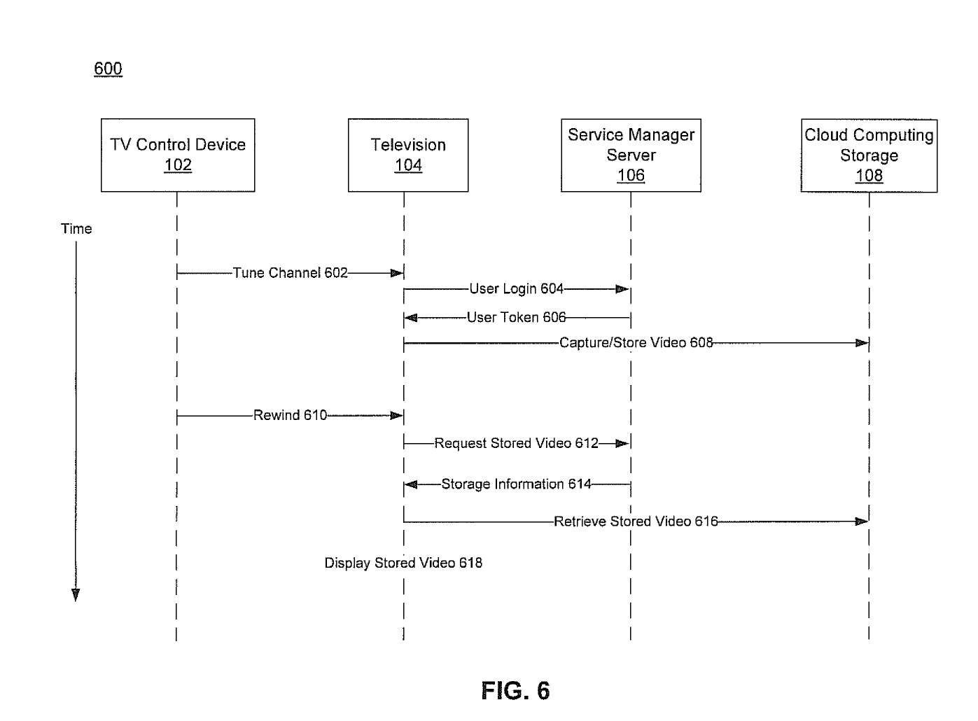

FIG. 6 is a timing sequence diagram 600 for storing television content in accordance with an embodiment of the invention. Note that within the timing sequence diagram 600, time progresses vertically down diagram 600 as represented by the vertical downward pointing “Time” arrow.

Within the timing sequence diagram 600, a user can utilize the television control device 102 to activate (or turn on) and tune the television 104 to a specific television channel, as represented by arrow 602. Next, the television 104 can log into the service manager server 106 via the Internet 110 to start the process of storing or recording the video content of the currently tuned television video, as represented by arrow 604. After the log-in process, the service manager server 106 can transmit a user token (e.g., that can include information for storing the television show) to the television 104 via the Internet 110, as represented by arrow 606. The television 104 receives the user token and transmits it to the cloud computing storage 108 via the Internet 110, as represented by arrow 608. Note that the cloud computing storage 108 receives the user token, extracts information from it, and starts storing (or capturing or recording) the live television video of the tuned channel of the television 104, also represented by arrow 608. It is noted that in an embodiment, the cloud computing storage 108 can continue storing or recording any live television video of whatever channel the television 104 is tuned into during the remainder of the timing sequence diagram 600.

Within FIG. 6, the user can cause the television control device 102 to generate or convey a rewind signal or instruction to the television 104 indicating that the user wants to watch previously recorded television video, as represented by arrow 610. Note that the user may have caused the television control device 102 to generate or convey the rewind signal because the user may have missed watching something on the television 104. For example, the user may have stepped away from watching the tuned television show to go to another room, such as the kitchen. Once the user has returned to the television, the user may want to watch what he or she missed while away from the television.

After receiving the rewind signal, the television 104 can transmit a request for the stored video to the service manager server 106 via the Internet 110, as represented by arrow 612. After receiving the request for the stored video, the service manager server 106 can transmit to the television 104 via the Internet 110 the corresponding storage information for the stored video within the cloud computing storage 108, as represented by arrow 614. After receiving the storage information, the television 104 can use it to retrieve the stored video from the cloud computing storage 108 via the Internet 110, as represented by arrow 616. After receiving the stored video, the television 104 can then playback and display the stored video and also enable the user to rewind, fast forward, and skip ahead the stored video during playback, as represented by “Display Stored Video” 618.

Note that in one embodiment, a user can disable the continuous recording functionality as described with reference to FIGS. 5 and 6. For example, a user may use the television control device 102 to disable the continuous recording functionality so that the cloud computing storage 108 does not record over stored video that the user still wants to watch at a later time.

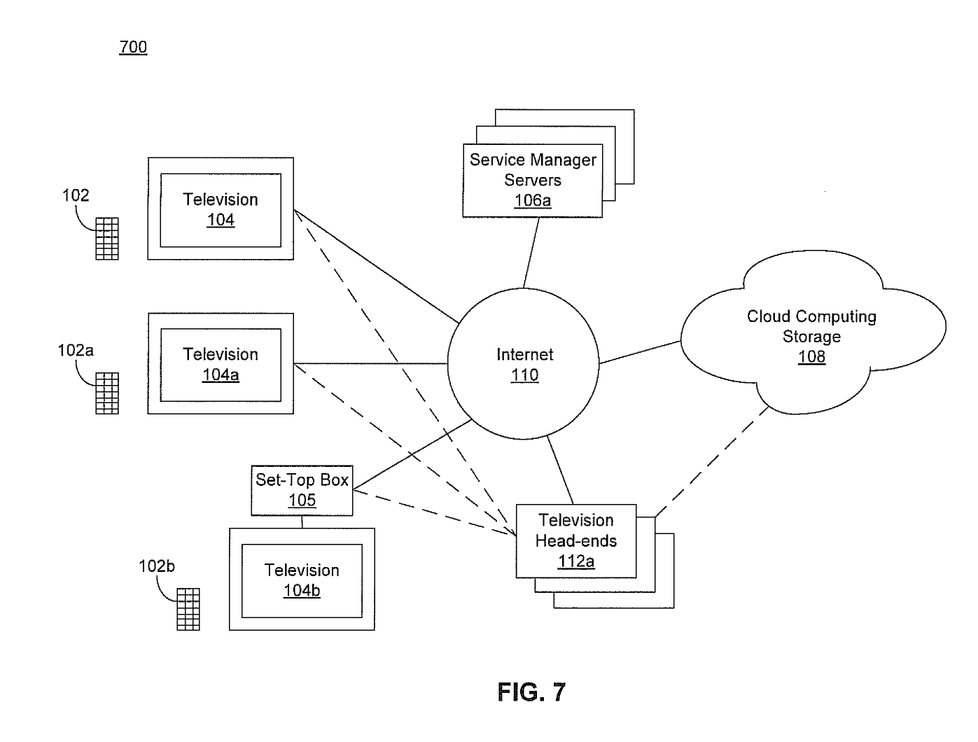

FIG. 7 is a block diagram of a system 700 for storing television content in accordance with various embodiments of the invention. It is noted that system 700 can operate in any manner similar to the system 100 as described herein, but is not limited to such. The system 700 can include, but is not limited to, the television 104 and its corresponding control device 102, a television 104a and its corresponding control device 102a, a television 104b and its corresponding control device 102b and a set-top box 105, multiple service manager servers 106a, the cloud computing storage 108, multiple television head-ends 112a, and the Internet 110. Specifically, the televisions 104 and 104a, the service manager servers 106a, the cloud computing storage 108, and the television head-ends 112a can each be coupled to the Internet 110, thereby enabling them to communicate.

In one embodiment, the television 104b does not include a computing system. As such, the television 104b can be coupled to the set-top box 105, which can be coupled to the Internet 110. In this manner, the set-top box 105 can communicate with those devices coupled to the Internet 110. It is pointed out that in various embodiments, the set-top box 105 can operate in any manner similar to the television 104 as described herein, but is not limited to such. In addition, in various embodiments, the television head-ends 112a can be coupled to the televisions 104 and 104a and set-top box 105 via, but is not limited to, cable television technology, satellite television technology, and broadcast television technology (which are represented by the dashed lines between the television head-ends 112a and the televisions 104 and 104a and set-top box 105). Furthermore, in various embodiments, the television head-ends 112a can be coupled to the cloud computing storage 108 via, but is not limited to, cable television technology, satellite television technology, and broadcast television technology (which are represented by the dashed line between the television head-ends 112a and the cloud computing storage 108). It is noted that in an embodiment, the televisions 104 and 104a, the service manager servers 106a, and the set-top box 105 can each be implemented in a manner similar to computing system 800 of FIG. 8, but is not limited to such.

It is noted that the system 700 may not include all of the elements illustrated by FIG. 7. Moreover, the system 700 can be implemented to include one or more elements not illustrated by FIG. 7. It is pointed out that the system 700 can be utilized or implemented in any manner similar to that described herein, but is not limited to such.

FIG. 8 is a block diagram of an exemplary computing system 800 that may be used in accordance with various embodiments of the invention. It is understood that system 800 is not strictly limited to be a computing system. As such, system 800 is well suited to be any type of computing device (e.g., server, desktop computer, laptop computer, portable computing device, database computer system, handheld computing device, set-top box, etc.) in accordance with various embodiment of the invention. In its various implementations, system 800 may not include all of the elements illustrated by FIG. 8, or system 800 may include other elements not shown by FIG. 8. Within discussions of various embodiments in accordance with the invention herein, certain processes and operations are discussed that can be realized, in some embodiments, as a series of instructions (e.g., software program, modules, and the like) that reside within computer readable memory or storage of computing system 800 and executed by a processor(s) of system 800. When executed, the instructions can cause computer 800 to perform specific operations and exhibit specific behavior which are described herein, but are not limited to such.

Computer system 800 can include an address/data bus 810 for communicating information, one or more central processors 802 coupled with bus 810 for processing information and instructions. Central processor unit(s) 802 may be a microprocessor or any other type of processor. The computer 800 can also include data storage features such as computer usable volatile memory 804, e.g., random access memory (RAM), static RAM, dynamic RAM, etc., coupled with bus 810 for storing information and instructions for central processor(s) 802, computer usable non-volatile memory 806, e.g., read only memory (ROM), programmable ROM, flash memory, erasable programmable read only memory (EPROM), electrically erasable programmable read only memory (EEPROM), etc., coupled with bus 810 for storing static information and instructions for processor(s) 802.

System 800 of FIG. 8 can also include one or more signal generating and receiving devices 808 coupled with bus 810 for enabling system 800 to interface with other electronic devices. The communication interface(s) 808 of the present embodiment may include wired and/or wireless communication technologies. For example, in one embodiment of the invention, the communication interface 808 is a serial communication port, but could also alternatively be any of a number of well known communication standards and protocols, e.g., a Universal Serial Bus (USB), an Ethernet adapter, a FireWire (IEEE 1394) interface, a parallel port, a small computer system interface (SCSI) bus interface, an infrared (IR) communication port, a Bluetooth wireless communication adapter, a broadband connection, and the like. In another embodiment, a cable or digital subscriber line (DSL) connection may be employed. In such a case the communication interface(s) 808 may include a cable modem or a DSL modem.

Optionally, computer system 800 can include an alphanumeric input device 814 including alphanumeric and function keys coupled to the bus 810 for communicating information and command selections to the central processor(s) 802. The computer 800 can also include an optional cursor control or cursor directing device 816 coupled to the bus 810 for communicating user input information and command selections to the processor(s) 802. The cursor directing device 816 can be implemented using a number of well known devices such as, but not limited to, a mouse, a track ball, a track pad, an optical tracking device, a touch screen, etc. Alternatively, it is appreciated that a cursor can be directed and/or activated via input from the alphanumeric input device 814 using special keys and key sequence commands. The present embodiment is also well suited to directing a cursor by other means such as, for example, voice commands.

The system 800 of FIG. 8 can also include an optional computer usable mass data storage device 818 such as a magnetic or optical disk and disk drive (e.g., hard drive or floppy diskette) coupled with bus 810 for storing information and instructions. The system 800 can include an optional display device 812 coupled to bus 810 of system 800 for displaying video and/or graphics. Note that the optional display device 812 may be implemented with different technologies. For example, the optional display device 812 may be implemented with, but is not limited to, a cathode ray tube (CRT), flat panel liquid crystal display (LCD), field emission display (FED), plasma display, light emitting diode (LED) display, or any other display device suitable for displaying video and/or graphic images and alphanumeric characters recognizable to a user.

Within FIG. 8, note that the volatile memory 804 may store a recording television content module 820 in accordance with various embodiments of the invention. The recording television content module 820 may include instructions to cause the system 800 to operate or function in any manner similar to that described herein, but not limited to such. It is pointed out that in various embodiments, the recording television content module 820 (or one or more of its components) may be stored by the volatile memory 804, or the non-volatile memory 806, or the mass data storage device 818, or any combination thereof.

It is noted that the components associated with system 800 described above may be resident to and associated with one physical computing device. However, one or more of the components associated with system 800 may be physically distributed to other locations and be communicatively coupled together (e.g., via one or more networks).

It is noted that the system 800 may not include all of the elements illustrated by FIG. 8. Furthermore, the system 800 can be implemented to include one or more elements not illustrated by FIG. 8. It is pointed out that the system 800 can be utilized or implemented in any manner similar to that described herein, but is not limited to such.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

What is claimed is:

1. A method comprising:
a server receiving data from a television via a communication medium, wherein said data comprising an identifier of a television channel that said television is tuned to;
said server transmitting a token to said television via the communication medium;
said television transmitting said token to a storage device via the communication medium; and
said storage device storing a live broadcast television video from said television channel.

2. The method of claim 1, further comprising:
said television receiving a selection to view said stored live broadcast television video later; and
after said receiving said selection, said television transmitting a stop storing signal to said storage device.

3. The method of claim 2, further comprising:
said television receiving a request for a listing of a video stored by said storage device; and
after said receiving a request for a listing, said television displaying said listing of a video stored by said storage device.

4. The method of claim 3, further comprising:
said television receiving a selection via said listing to view said stored live broadcast television video; and
said television transmitting a request signal to said server for said stored live broadcast television video.

5. The method of claim 1, further comprising:
said television receiving a selection to view said stored live broadcast television video now; and
after said receiving said selection, said television transmitting a request to said server for said stored live broadcast television video.

6. The method of claim 5, further comprising:
said server receiving said request; and
after said receiving said request, said server transmitting storage data to said television.

7. The method of claim 6, further comprising:
said television receiving said storage data; and
said television using said storage data to retrieve said stored live broadcast television video from said storage device.

8. A method comprising:
a server receiving data from a television via a communication medium, wherein said data comprising an identifier of a television channel that said television is tuned to;
said server transmitting a token to said television via the communication medium;
said television transmitting said token to a cloud storage via the communication medium;
said cloud storage storing a live broadcast television video from said television channel; and
said television receiving a rewind signal.

9. The method of claim 8, wherein said token comprising an address of said cloud storage.

10. The method of claim 9, wherein said token comprising said identifier of said television channel.

11. The method of claim 8, further comprising:
said television transmitting a request signal to said server for said stored live broadcast television video.

12. The method of claim 1, further comprising:
said server receiving said request; and
after said server receiving said request, said server transmitting storage data to said television.

13. The method of claim 12, further comprising:
said television receiving said storage data; and
said television utilizing said storage data to retrieve said stored live broadcast television video from said cloud storage.

14. The method of claim 13, further comprising:
said television playing back said stored live broadcast television video; and
said television enabling fast forward and rewind of said playing back of said stored live broadcast television video.

15. A method comprising:
a server receiving data from a television via a communication medium, wherein said data comprising an identifier of said television and an identifier of a television channel that said television is tuned to;
said server transmitting a token to said television via the communication medium, wherein said token comprising said identifier of said television channel;
said television transmitting said token to a cloud storage via the communication medium;
said cloud storage receiving said token;
said cloud storage storing a live broadcast television video from said television channel.

16. The method of claim 15, further comprising:
said television receiving a selection to view said stored live broadcast television video later; and
after said receiving said selection, said television transmitting a stop storing signal to said cloud storage.

17. The method of claim 16, further comprising:
said television receiving a request for a listing of a video stored by said cloud storage; and
after said receiving a request for a listing, said television displaying said listing of a video stored by said cloud storage.

18. The method of claim 17, further comprising:
said television receiving a selection via said listing to view said stored live broadcast television video; and
said television transmitting a request signal to said server for said stored live broadcast television video.

19. The method of claim 15, further comprising:
said television receiving a selection to view said stored live broadcast television video now; and
after said receiving said selection, said television transmitting a request to said server for said stored live broadcast television video.

20. The method of claim 19, further comprising:
said server receiving said request; and
after said receiving said request, said server transmitting storage data to said television;
said television receiving said storage data; and
said television using said storage data to retrieve said stored live broadcast television video from said cloud storage.
